(19) United States
(12) Patent Application Publication
(10) Pub. No.: US 2004/0024784 A1
(43) Pub. Date: Feb. 5, 2004

(54) Information system for manipulating data related to the ordering and performance of services and communication of results

(76) Inventors: Walter Dale Spall, Los Alamos, NM (US); Robert Kent Mansfield, Plano, TX (US); James Alfred Seely, Flower Mound, TX (US); Richard Hennigan, Addison Dallas, TX (US)

Correspondence Address: George R. Schultz, Schultz & Associates, P.C., One Lincoln Centre, Suite 525, 5400 LBJ Freeway, Dallas, TX, 75240, US

(21) Appl. No.: 10/411,703

(22) Filed: Apr. 9, 2003

Related U.S. Application Data
(60) Provisional application No. 60/371,047, filed on Apr. 9, 2002.

(51) Int. Cl. G06F 17/00

(52) U.S. Cl. 707/104.1

(57) ABSTRACT

A method is provided for manipulating data related to the ordering and performance of services and communication of results. The invention discloses a method of relating various databases with reporting engines to combine information in useful ways to coordinate customer location information, provider service information, contract information, product information and pricing information, and submit required requests to service partners to complete the work orders. Accounting and budgeting information also can be tracked, along with the submission, status and completion of work orders.

### CROSS-REFERENCE TO RELATED APPLICATIONS

This application claims priority to Provisional Application Serial No. 60/371,047, entitled Database Method and Apparatus for Communicating the Identity of Various Chemically Tagged Fluids, Compounds, and Articles, by Spall et al., filed Apr. 9, 2002.

### FIELD OF THE INVENTION

This invention relates to an information system for collecting and organizing data and more particularly to a collection of databases relating to the creation, status information, and results of services preformed by a provider for a customer.

### BACKGROUND OF THE INVENTION

Certain fields of endeavor exist where a service provider provides services for customers which require the service provider to operate on certain products of the customer and return results to the customer. One such field of endeavor is the testing of petroleum products such as oil or gasoline of different companies for the presence of certain chemical markers. For example, a single service provider can test multiple samples of gasoline from several different companies for one or a number of different chemical markers. The service provider offers these services to many customers each having many samples. Each customer requires testing results for each sample on which the service provider conducts tests. Additionally, the samples on which the tests are to be conducted are usually located at multiple different locations.

Performing multiple services for customers on multiple products in different locations can be difficult to organize and control. Other difficulties arise in cataloguing service requests and in reporting results to the customers. Currently, the process involves a customer meeting with one or more providers of the desired services. A paper “service order” is typically filled out by the customer to request services for each product. If the customer has a large number of products or a large number of locations, the ordering of services is time intensive. Also, if the provider can provide a large number of types of services, determining what services to select can be confusing to the customer and increase the amount of time required to order the services.

The prior art provides the customer inefficient methods of tracking the status of the services once a service order has been completed. Currently an inquiry as to the status of the service order requires that the customer contact the service provider. The provider must then determine the status of the service order and contact the customer with the status information. Such a process is inefficient and time consuming.

Once the services requested by the service order are complete, the results are typically sent to the customer. The customer is responsible with interpreting the results. For example, if testing is done at multiple locations, the customer will be given the results of the testing but not in an easily understood format.

What is needed is a flexible information system that may be shared by the provider, agents of the provider, and customers. There is a need for an information system which permits the provider and customers to share status and other data related to the selected service. Also, there is a need for an information system which allows customer's to view other related data associated with service requests, products or locations in an easy to understand report to provide useful information. There is a need for an information system which allows customers to create reports and logically associate a service requests based on the information.

Finally, there is a need for an information system which takes advantage of the speed and accessibility of state of the art computer networks and relational databases. A database is a collection of data that is organized so that its contents can easily be accessed, managed, and updated. Databases contain aggregations of data records or files, such as sales transactions, product catalogs and inventories, and customer profiles. The most prevalent type of database is the relational database, a tabular database in which data is defined so that it can be reorganized and accessed in a number of different ways.

### SUMMARY OF THE INVENTION

The present invention provides an information system comprising a collection of databases relating to the creation, status, and results of services preformed by a provider for a customer.

The preferred embodiment of the current invention is an Internet based software application. The system is implemented in a modular manner that lends itself to flexibility.

The preferred embodiment provides a group of correlated databases to organize information related to a service transaction between a customer and a service provider. The databases include information about the customer, such as his identity, his products and the location of his products. Other information in the databases includes information related to the service provider, agents of the service provider and the types and prices of the available services. A number of client specific service product databases are provided. Each service product database contains only the services related to the intended relationship between a specific customer and the service provider. The service product database reduces potential confusion between customers and services. It also allows each customer to easily select and order desired services. A product list database is also provided which contains an identification of all the products on which services may be performed. A location list database is also provided which contains the locations of all the products. The “service order” is replaced by the customer accessing the service product database, selecting the service and providing location of the product.

After the service and location is selected by the customer, a service database is created that contains the selected service and location. A “work order” is issued for the service and is sent via the Internet (or other computer network) to the provider who will carry out the service. The system provides a method to track customer budget information during the completion of the service. Once the service is completed, the results are entered into a service database.

The information system contains various report generating software applications that combine the information in various databases, including the service database, to create summary reports for the customer. The system provides for interpretation of the data into summary results, such as “pass/fail”, which are quickly understood.

The customer can view the status of the selected service and create reports at any time through the computer network. This allows the customer to view data associated with one or more service requests, products or locations in a summary report. The system allows the customer to create reports and request new services based on the information available about the pending or recently completed services.

The system also allows the provider to view the status of selected services and create reports at any time via the computer network. This allows the provider to view the data associated with one or more service requests, products or locations in a summary report. The system also allows the provider to alter data related to the services which are offered, pricing information and various rules which apply to data interpretation.

### DETAILED DESCRIPTION OF THE DRAWINGS

A better understanding of the invention can be obtained from the following detailed description of one exemplary embodiment as considered in conjunction with the following drawings in which:

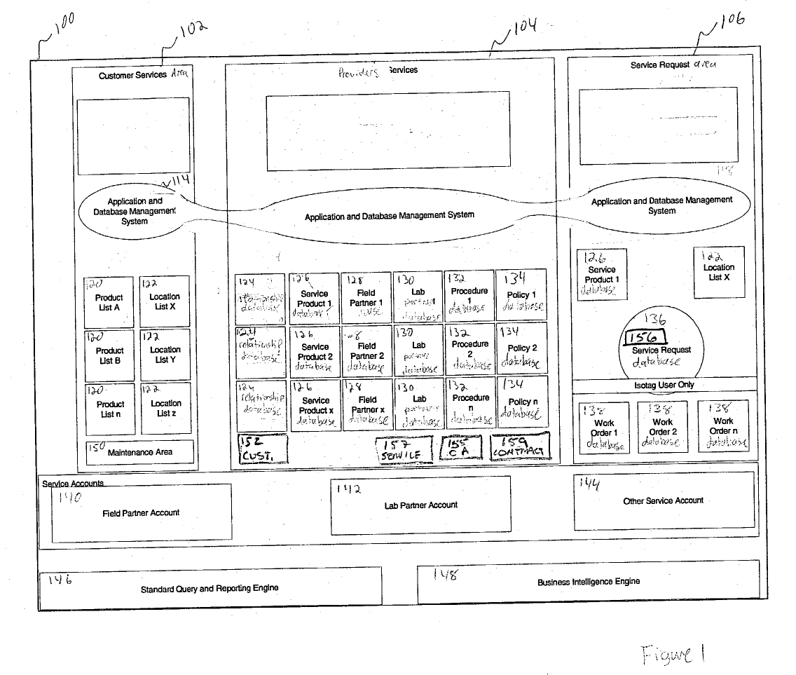

FIG. 1 is a block diagram depicting an information system according to the present invention;

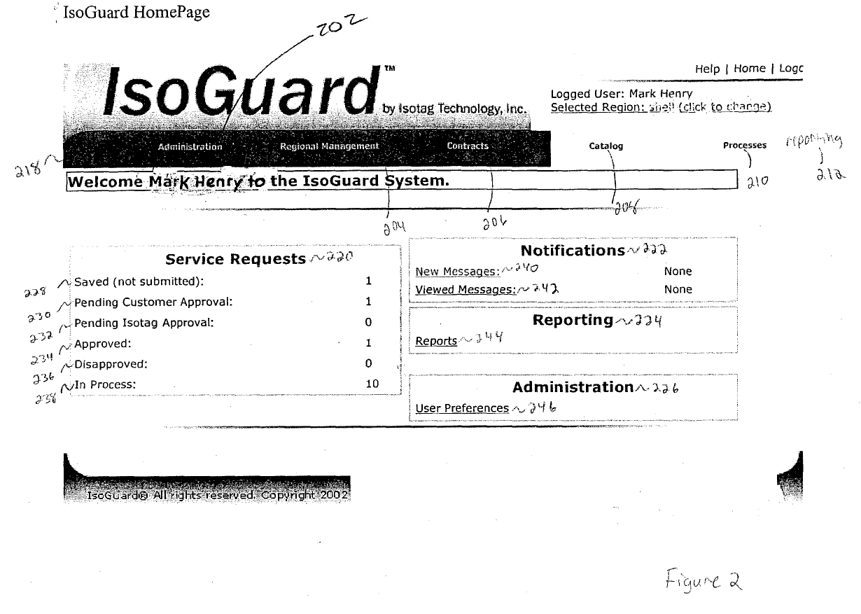

FIG. 2 is a screen shot from a customer web browser for use in the present invention;

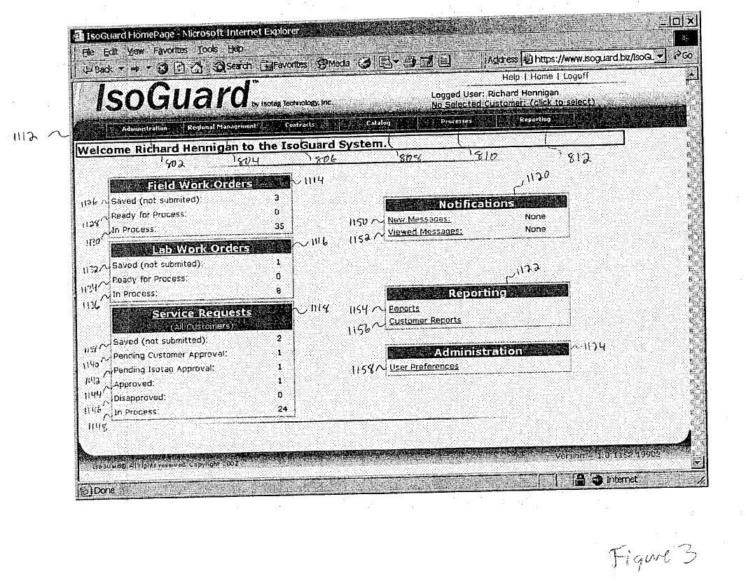

FIG. 3 is a screen shot from a provider web browser for use in the present invention;

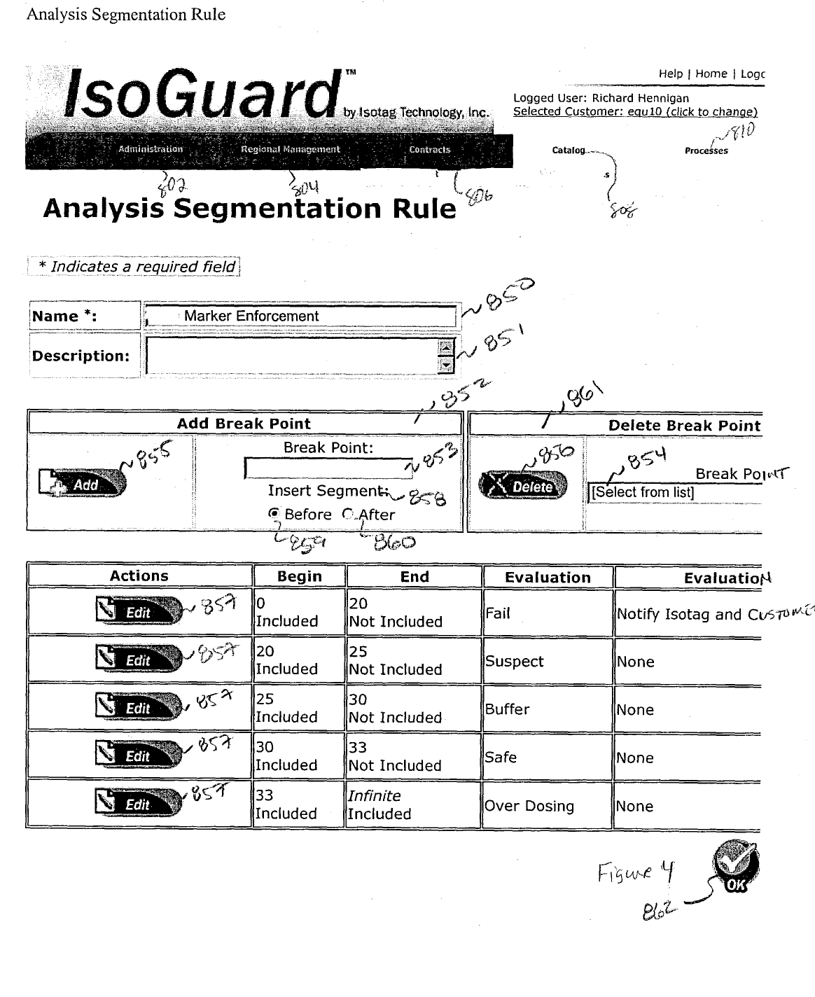

FIG. 4 is a screen shot from a provider web browser depicting a grading and notification area of use in the present invention.

### DETAILED DESCRIPTION OF EXEMPLARY EMBODIMENTS

With reference to FIG. 1, in the preferred embodiment, information system 100 is a collection of relational databases which can be accessed using a standard Internet browser.

Information system 100 is controlled and maintained by a provider of services. There are three primary groups that use information system 100, customers, providers, and partners of the provider.

For example, a provider may provide a service of testing for chemical markers in the oil and gasoline industry. A customer, for example, may be a producer of gasoline. If the customer desires to add a chemical marker to its gasoline, the customer would be able to use the system to select various retail locations for testing, order a service provider to test gasoline for the chemical marker, review a history of testing results, and graphically analyze them.

In this example, the provider would use the system to organize sending a work order to various laboratories that conduct tests for chemical markers, track the status of the tests, maintain test results, design testing procedures, and assist customers with the processing of requested services and the status of the services.

Provider partners are used by the provider on an as needed basis. For example, the provider may use a third party company or field partner to collect gasoline samples from retail gasoline stations to whom the customer has sold its gasoline. The provider may also use a partner to perform analysis on the samples collected from the retail gasoline stations. Partners use information system 100 to obtain instructions on the testing procedures and policies, for a list of field locations to be tested, and what specific procedures or tests are to be performed on the samples collected. Partners also use the system to report results once the tests are finished.

The preferred embodiment of the invention is executed on a database manager 114. Database manager 114 provides users the capabilities of controlling read/write access, specifying report generation, and analyzing usage of the data in all the databases. The database manager 114 logic is based on Structured Query Language (SQL) as is known in the art. SQL is a standard language for making interactive queries from and updating a database such as IBM's DB2, Microsoft's Access, and database products from Oracle, Sybase, and Computer Associates.

Information system 100 is divided into three areas where each group interacts with the system, customer service area 102, provider's service area 104, and service request area 106.

Customer service area 102 controls and manages the interactions of the customer with information system 100. The customer interacts with the system by providing identifying information about itself, its products and locations, and the services it needs.

Provider's service area 104 is used by provider or system administrators who have password authorized access. The provider interacts with information system 100 to create and manage defined relationships with customers, services available to the customer, relationships with partners to perform services, and procedures and policies for performing the services.

Service request area 106 is used by the partners for the entry of data related to the services. Service request area 106 is also used by the customer and the provider for viewing the status of services, as well as for reviewing the data entered by the field and lab partners.

Information system 100 includes several databases that include lists of information. These include field partner database 128, lab partner database 130, product list database 120, location list database 122, and customer database 152. Field partner database 128 contains a list of names and addresses of field partners and the services of which they are capable. Lab partner database 130 contains names and addresses of lab partners and the services of which they are capable. Product list database 120 contains a list of customer's products. Location list database 122 contains the locations of customer's products. Customer database 152 includes the names and addresses of the customers of the provider.

Other databases in information system 100 contain records of similar information which are correlated as will be later described. Examples of this include the policies database 134, procedures database 132 and contract database 159. Policies database 134 and procedures database 132 are groups of pointers which point to documents that show exactly how various procedures of the provider are to be completed and how policies of the provider are to be carried out. For example, detailed laboratory testing of gasoline samples or detailed collection methods for gathering samples of gasoline. Contract database 159 includes a listing of all of the different services which are available from provider. For instance, the service of testing and reporting results of individual chemical marker concentrations in gasoline and reporting results to the customer. A sub-account of the contract database is contract account database 155. This database includes cost budgeting information for each customer as will be described later. Still other databases include combinations of information in useful association. Examples of these are the service product database 126, the service request database 136, work order database 138, the service database 157 and the relationship database 124.

Relationship database 124 is created by the provider and is based on the intended interactions between the customer and provider. The bounds of the relationship database are enforced as a series of flexible categories. If an attempt is made to add data to these categories that does not fit, the invention will reject the attempt until the categories are modified to accept the data.

Relationship database 124 contains a master contract field and a sub-contract field. Master contract field contains the name of the customer, a description of the customer's business, and the start and end date of the relationship customer has with provider. For every master contract field there is at least one sub-contract field containing a list of services associated with the master contract field and other information such as the price of the services, and the delivery time for each service. Also in relationship database 124 are miscellaneous relationship parameters such as exclusivity of the relationship and general remarks. Relationship database 124 also includes information about the geographical regions in which the customer does business.

There can be more than one relationship database 124 for each customer. For example, one relationship database 124 could be for a gasoline producer who wants to monitor gasoline that has been sold to retail gasoline stations. A second example of a relationship database 124 might be a gasoline producer who wants to monitor the gasoline in tanker trucks used by the gasoline retailer to transport the gasoline to various regions.

The types of services needed by the customer are examined by the provider to determine if more than one relationship database 124 is needed. For example, if a gasoline retailer has a relationship database 124 based on customer's desire to test retail gasoline stations and the customer now wants to also test marina stations, a new relationship database 124 would be created. The new relationship database 124 would be necessary because of the different types of services involved in testing a marine station as opposed to testing a retail gasoline station.

The provider uses relationship database 124 to create product list 120 and service product database 126. Product list 120 contains all of customer's products on which providers services could be used, within the bounds of relationship database 124. In the preferred embodiment, product list 120 is the list of products, defined in relationship database 124, that may be sampled, scanned, analyzed or tested. For example, “products” may include a brand, product line, shipping carton and/or a specific stock keeping unit (SKU). A SKU is identification, usually alphanumeric, of particular product that allows the product to be tracked. If, for example, a gasoline retailer sold regular and super gasoline but not diesel, then regular and super gasoline would be listed in product list 120. If the gasoline retailer later added diesel to the types of gasoline sold, and the customer wanted to test the diesel along with the regular and super gasoline, then diesel would be added to product list 120. Products can be added to the product list so long as the addition potential services are within the bounds of relationship database 124 and service product database 126.

Service product database 126 is a database that contains all the services available to the customer that can be conducted on products within the boundaries of relationship database 124 and product list 120. The service product database is generated by the customer after consultation with the provider in order to determine what services may be required. Continuing with the prior example, if the gasoline retailer desires the service product of testing retail gasoline stations, then he can access the product service database 126 and view a range of service products. Other services/products which are provided to other customers of the provider are not accessible. For example, the gasoline retailer cannot access services for testing jet fuels, or tanker ships, even though these services may be offered by the provider. Because the customer only sees the services related to the relationship defined by the relationship database 124, the customer can view a relatively small list of relevant services rather than a relatively large list of irrelevant services. The relatively small list of relevant services presented to the customer helps to alleviate confusion about what services are available to satisfy the customer's needs.

The provider inputs contract pricing information into contract account subdatabase 155. Contract account subdatabase 155 is a budgeting tool which allows the provider to allocate certain funds to the performance of each service for the customer.

In order to modify the account balance information in the contract account subdatabase, the provider accesses the embedded information in the web form under the contract account balance. This information is not available to the customer and cannot be modified except by the provider. Upon performance of the service, the allocated funds are debited automatically by SQL logic and can be reported to the customer for budgeting purposes.

The customer inputs the data into location list 122. Location list 122 is a database containing a list of addresses (or other real property location information) where services offered by the provider are to be performed. The invention allows location list 122 to be imported from existing customer or distribution lists. The lists may include physical addresses of retailers, distributors or wholesalers. Location list 122 may be organized by geographic region. For example, a retail gasoline station may be located in a Postal Code (76051), in a Metro Area (Dallas), in a state (Texas), in a region (Tex, Ark, Okla), or within a division or company (North American Operations). Any of the regional levels may be used to limit a service, such as a sampling or testing event.

Location list 122 also contains any characteristic or property of each location that the customer desires to track or monitor. For example, such characteristics may include the type of gasoline station or item, the owner of each gasoline station or other contact information. The customer has access to location list 122 and can change, add or delete locations where the products or items may be tested.

Once location list 122 and service product database 126 are completed, the customer can access service request area 106 and select the services and the location at which the customer wants the services to be performed. One or more services may be selected for one or more locations. Once the customer selects the services and the location, a corresponding service request database 136 is created which contains the selected service and the selected location for that customer.

Service request database 136 is a combination of one or more of the selected services and one or more of the selected locations with prewritten contracts and a set of procedures and policies. Service request database 136 associates the type of service to be done from contracts database with the procedures and policies databases and with the products and the locations of the products according to the appropriate service request logged in relationship database 124. Management system 114 accesses procedures database 132 and policies database 134 to obtain the set of procedures and policies related to the selected services and locations. Management system further accesses contract database 159 to retrieve the appropriate contract document. The SQL logic combines the selected pieces into service request database 136. Service request database 136 also extracts pricing and timing data from relationship database 124. To extract the pricing and timing data, the SQL logic uses the selected service request in service request database 136 to cross-reference the relationship database 124.

The invention provides the ability to “nickname” service requests, in service request database 136, using standard database techniques, without losing the detail stored in each record. The customer accesses particular records in service request database 136 with user-friendly names (i.e. May 2002 Initial Sampling and Testing for North Texas) as opposed to obscure record locators. However, each service request record can still be deconstructed into line item events at specific locations. The line items may be used to access specific information in a database object. For example, field partners need exact locations and testing instructions with detailed procedures and policies that ensure agents in one market perform the same procedures as agents in other markets.

Information system 100 can build service requests in service request database 136 based on automatic functions. These functions may be recurring events generated by dates, date events or single events generated by the system to repeat a previous testing event. Work orders will be assigned data or analysis information that will then be re-associated with the customers' original service request and re-entered in service request database 136 as a new record.

For example, the price record for sampling and testing gasoline at a retail gasoline station would be entered in relationship database 124 and associated with a customer's identity, expected total completion time and time for sampling and laboratory work would also be entered and associated with the customer's identity in relationship database 124. Using SQL logic, service request database 136 can reference the testing of a particular retail gasoline station in relationship database 124 and extract the corresponding pricing and timing data.

A “service proposal” is created for each customer for each service and product to be submitted to the provider. Once the service proposal is created, the customer may submit it to the provider for approval. When the service proposal is submitted, the price for the contract is debited from allocated funds as shown in the contract account subdatabase 155. The invention provides that the “service proposal” may be withdrawn by the customer at any stage prior to substantiate completion.

The provider reviews the service proposal in service request database 136 and if the provider approves the service proposal, then field and lab partners are assigned by the provider to perform the selected services at the selected locations. If not, a message is sent to the customer detailing the reasons for rejection.

The field partners are selected from field partner database 128. Field partner database 128 is created by the provider and contains all the names and contact information of field partners who can perform one or more of the services the provider offers. For example, if the gasoline provider wants to sample gasoline at a selected gasoline retail stations in the state of Texas, in field partner database 128 will be the contact information for a company or individual who can perform the sampling of the gasoline at the selected retail gasoline stations in Texas. A filter function, as known in the art, may be used to find the correct field partner. If field partner database 128 does not contain a field partner who can perform the selected service, then the provider will find a field partner by conventional means known in the art and add that field partner to field partner database 128. The new contact information will be accessible the next time that particular service is required.

The lab partners are selected from lab partner database 130. Lab partner database 130 is created by the provider and contains all the names and contact information of lab partners who can perform one or more of the services that the provider offers. For example, if the gasoline retailer wants to test the moisture level of regular gasoline, in lab partner database 130 will be the contact information for a company or individual who can perform moisture testing on regular gasoline. A filter function known in the art may be used to find the correct lab partner. If lab partner database 130 does not contain a lab partner who can perform the selected service, then the provider will find a lab partner by conventional means known in the art and once a lab partner is found, that lab partner is added to lab partner database 130 and will be accessible the next time that particular service is required.

Once the field and lab partners are assigned to perform the service or services selected by the customer at the location or locations selected by the customer, the service request record is complete and a corresponding record is created in work order database 138 using SQL logic.

In order to physically accomplish the requested service, the provider must distribute a work order to each appropriate partner. Work order database 138 accomplishes this task. To do so, work order database 138 searches all approved services in service request database 136 and organizes each service by individual store or item. A work order disassembles a service request into line item events at specific locations that may then be assigned to the appropriate partner. After work order database 138 has been created, a record is created of all the services that are to be performed on an individual store or item. Work order database 138 converts one or more approved service requests into a specific event that can be reassembled into a common set of tasks and then delivered to field or lab partners. Work order database 138 uses SQL logic to create the most efficient unit of service that may be assigned a group or individual. After the record is created, it is sent to each field and lab partner who will perform a service associated with each store or item.

The work order is communicated as a purchase order that is submitted to a field partner or lab account to commission specific work. It provides the field partner or lab account with a tracking number that relates data back to the customer's service request. Where multiple qualified partners are available, the provider may choose the partner that maximizes responsiveness and field partner efficiency.

As an example, many of the services requested by the customer involve multiple separate services. For example, testing gasoline at a retail gasoline station involves at least two separate services of collecting the gasoline using a field partner and then testing the gasoline using a lab partner. The customer may desire to track whether or not a specific retail gasoline station has passed various tests. Therefore, all the various services to be performed on the gasoline from that specific store are grouped by that specific store.

The work orders sent to field partners and lab partners from work order database 138 are sent as records using extensible markup language (XML) web services available from Microsoft, Inc. and known in the art. XML web services are small reusable applications written in XML. XML is a universal language for data exchange. XML web services allow for data to be communicated across the Internet or internal intranet, between otherwise unconnected sources that are enabled to host or act on the XML web services.

The record is sent to various field partner accounts 140 and lab partner accounts 142 based on the types of services to be performed on each product and location. For example, if a retail gasoline station is being tested, the record may contain the services of sampling the gasoline, transporting the gasoline to a laboratory or laboratories for analysis, and testing the gasoline for moisture and impurities. The record for the one retail gasoline station would be sent to a field partner who can sample the gasoline, a field partner who can transport the gasoline, a lab partner who can test the gasoline for moisture and a second lab partner who can test the gasoline for impurities. Other service account 144 is used for services that are not field or lab related. For example, a legal service, such as determining if testing of a retail gasoline station can be done without the owner's permission would be a service that is sent to other service account 144. Work orders sent to other service account 144 are tracked by a tracking number in the same way as work orders sent to field partner account 140 and lab partner account 142.

In the preferred embodiment, field partner account 140 and lab partner account 142 are databases maintained at each individual field and lab partner's place of business. The software used to access the field partner account 140 and lab partner account 142 must only be capable of reading XML.

As the field and lab partners complete each assigned service, the field and lab partners enter the results into field partner account 140 and lab partner account 142. The results may be a simple “task completed” or a more complex set of range or concentration data, or the like. Field partner account 140 and lab partner account 142 send a list of completed tasks to service database 157.

Such a process uses XML and is known in the art. After service database 157 receives the results from field partner account 140 and lab partner account 142, the system updates the appropriate records so that the customer can track the status of each service. The system also “locks in” the funds allocated for the service in contract account subdatabase 155 thereby effectively debiting the customer's account.

If desired, the customer may request updates at regular intervals from the provider. These requests are transmitted to the partners by the provider through field partner account 140 and lab partner account 142.

Standard query and reporting engine 146 has access to all the information in information system 100 via application and database management system 114. Standard query and reporting engine 146 uses Congos by Impromptu, Crystal by Sea Gate, or other software known in the art for creating tables and charts from relational databases. For example, query reports are generated when the customer or provider queries information system 100 about all pending service requests that are past the due date. To satisfy such a query, standard query and reporting engine 146 queries service request database 136 and filters out all service requests that are past due. The service requests that are past due are then presented to the customer or the provider in a report. Other queries can be made, for example to determine the number of times a locations has been tested, the number of work orders a particular field partner has pending, or any other query that can be satisfied through filtering, cross referencing, or other SQL logic tools.

Business intelligence engine 148 has access to all the information in information system 100 via application and database management system 114 and has access to data imported from other systems such as an Excel spreadsheet in the customers system. Using Congos by Impromptu, Crystal by Sea Gate, or other software known in the art for creating tables and charts from relational databases, the data is imported from other systems and combined with data from information system 100. For example, a business budget report may be generated on all the expenses spent on a specific retail gasoline station. The report is generated by accessing business intelligence engine 148 and querying for all expenses related to the specific retail gasoline station. If that data is a database in information system 100, for example in contract account subdatabase 155, location list 122 or relationship database 1224, then business intelligence engine 148 will acquire the relevant data and combine the data with other data acquired from other systems available for similar queries and provide a business report to the customer showing all the expenses spent on a specific retail gasoline station. The customer accesses information system 100 through customer area 102.

Customer service area 102 contains maintenance area 150, product list 120 and location list 122. Maintenance area 150 is a database generated by the provider based partly on information provided by the customer and partly on information provided by the provider. Maintenance area 150 contains identification information about each specific customer. For example, name, address, contact information, demographics, account balances, and the different levels of authorization or access each employee of the customer has when interacting with the information system 100. The invention allows the provider to determine, and allow or disallow, the customer access to maintenance area 150.

In the preferred embodiment, the functions of the invention take place through an Internet-based application software system. The databases and main application reside on a server located at the provider's physical facility. The functions of the program may be accessed through an internet browser which allows a password protected access. However it should be understood that stand alone applications which provide the same functionality are also possible in alternate embodiments of the invention.

FIGS. 2 and 3 show various screen shots from the preferred embodiment of the invention.

The screen shot shown in FIG. 2 shows a customer side web browser display and navigation panel. There are five functional areas. The areas are tabs control 218, service requests 220, notifications 222, reporting 224, and administration 226.

Tabs control 218 provides access to the various databases in the system. Tab control 218 contains administration tab 202, regional management tab 204, contracts tab 206, catalog tab 208, processes tab 210, and reporting tab 212.

Administration tab 202 controls access to the users and user information in the relationship database 124. Administration tab contains two drop down menus, user's tabs and user's group tab. The users tab is used to access the name and contact information about each of customer's users able to access the system. The level of data access each of customer's users has is dependent on which user group the customer's user is associated. The user's group tab defines the level of access for each user group. For example, the customer may have four levels of access for all employees of the customer. Level 1 access provides full access to all the databases in the system and allows the employee to add, modify or delete any customer accessible data in the system. Level 2 access provides access to a more limited amount of data in the system. For example, the employee may have add, modify and delete access the location list 122 and service request database 136. Level 3 access provides add, modify or delete access to service request database 136. Level 4 access provides only read access to service request database 136 and work order database 138. The access and user information is stored in maintenance area 150.

Regional management tab 204 controls access to the customer and region information contained in the location list 122. Regional management tab 204 controls drop down menus for regions tab, customer tab, and locations lists tab. The regions tab accesses the region in which each location or item in location list 122 is located. For example, a retail gasoline store may be in the western region, or in the Texas region, or in the United States region depending on how the customer has organized the regions in location list 122. The customer tab accesses a listing of each individual location or item in location list 122. The location lists tab accesses a unique customer defined group of locations or items. For example, a named list might be “failed moisture” and list the retail gasoline stores that have failed a moisture test.

Contracts tab 206 controls access to the functions of the invention which control access to the information stored in relationship database 124. Under contracts tab 206 is master contract tab, sub contract tab, and contract services tab. The master contract tab accesses a master contract in relationship database 124. The master contract only contains the name of the customer, a description of customer's business, and the start and end date of the relationship customer has with provider. The sub-contract tab accesses a sub-contract in relationship database 124. The sub-contract contains information related to the services requested, timing and price. The contract services tab accesses service product database 136 and provides a listing of what provider services are associated with each customers product. The master contract, sub-contract, and listing of the services associated with each product can be read but not modified by the customer.

Catalog tab 208 controls access to the products and services selected by the customer. Under catalog tab 208 is product identifier tab, and service products tab. The product identifier tab accesses product list 120 and provides a complete list of the products in product list 120. The service products tab accesses procedures database 132 and provides both a group analysis and services plan for a specific named product.

Processes tab 210 controls access to status information of projects undertaken by the provider and allows the customer to order new services. Under processes tab 210 is service request tab. From the service request tab, the customer accesses service request database 136. The customer can accesses service request database 136 to order services or to check on the status of existing services.

Under reporting tab 212 is a report tab. From the report tab, the customer accesses standard query and reporting engine 146 and businesses intelligence engine 148.

Service request display 220 displays the status of the selected services in service request data base 136. Service request display 220 contains a saved category 228, a pending customer approval category 230, a pending provider approval category 232, an approved category 234, a disapproved category 236, and an in-process category 238. Saved category 228 indicates the number of services requests that have been recorded, but have not been submitted for approval in service request data base 136 and provides a link to each service request. Pending customer approval category 230 indicates the number of service requests that are pending the customer's approval and provides a link to the service requests that are pending the customer's approval in service request database 136. Pending provider approval category 232 indicates the number of service requests that are pending the provider's approval and provides the link to the service requests that are pending the provider's approval in service request database 136. Approved category 234 indicates the number of service requests that have been approved and provides a link to the service request that have been approved in service request database 136. Disapproved category 236 indicates the number of service request that have been disapproved by the provider and provides a link to the service requests that have been disapproved in service request database 136. In process category 238 indicates the number of service requests that have been issued as work orders and are in process of being completed and provides a link to the service requests that are in process in service request database 136.

Notifications display 222 catalogs the notifications that have been sent to the customer from the provider and is comprised of new messages category 240 and viewed messages category 242. New messages category 240 indicates the number of new messages sent by the provider to the customer and provides a link to those messages. Viewed messages category 242 indicates the number of messages viewed by the customer and provides a link to those viewed messages.

Reporting display 224 catalogs the reports the customer has generated. Reporting display 224 contains reports category 244. Reports category 244 indicates the number of reports that have been generated and provides a link to those reports in standard query and reporting engine 146 and business intelligence engine 148.

Administration display 226 allows the customer to customize the view of the web page display. Administration display 226 contains user preferences category 246. The user preferences category is used to adjust the appearance of the web page display.

From the browser page described in FIGS. 2, the customer can monitor the status of ongoing service projects. During the projects, the invention can forward alerts or notifications to the customer by email or displayed on the screen under the notification section 222. The notifications and grading area 156 (FIG. 1) can alert the customer to the need for additional tests or other activity or report a budget deficit or surplus by reporting completed services in a format of “pass/fail” or other in shorthand “tags” related to concentration ranges. For example, if a test service is failed, such as a chemical marker not being present in gasoline, an additional test may be requested by the customer for the provider to perform a more detailed analysis as to why the location failed the test. The additional test may include testing for the concentration of the marker to determine dilution of the gasoline. The additional test could also include a test for the presence or absence of additional markers.

Information system 100 may also suggest the testing of locations that are similar to the location that failed the test. For example, upon a retail gasoline station failing a test such as the absence of a chemical marker, using SQL, information system 100 would query location list 122 for all retail gasoline stations having the same owner as the failed retail gasoline station. Then grading and notification area 156 sends a notification to the customer suggesting the testing of all retail gasoline stations having the same owner as the failed retail gasoline station. The rules which govern which suggestions to be made to the customer can be comprised of any SQL command. The rules are stored in the miscellaneous field of the relationship database 136 and can only be accessed by the provider.

FIG. 3 is a screen shot from a provider's browser. On this web page there are seven functional areas. The areas are tab control 1112, filled work orders 1114, lab work orders 1116, service request 118, notifications 1120, reporting 1122, and administration 1124. Tab controller 1112 contains an administration tab 802, regional management tab 804, contracts tab 806, catalog tab 808, processes tab 810, and reporting tab 812.

Under administration tab 802 is a companies tab, a users tab, a customers users tab, a users groups tab, a customer user groups tab, and a manage types info tab. The companies tab is used to add general information about customers to the system. The name of the company is added along with contact information and a brief description of what the company does. The company information is stored in a company database 152. The users tab accesses the name and contact information of each of provider's employees which is authorized to access the system. The level of access each provider's employee has is dependent on the employee's user group. The user's group tab allows the provider to set the level of access for each user group. For example, the provider may have four levels of access for all employees of provider. Level 1 access provides full access to all the databases in the system and allows the employee to add, modify or delete any database in the system. Level 2 access provides access to a limited number of databases in the system. For example, the employee may have add, modify and delete access to field partner database 128, lab partner database 130, procedures database 132, policies database 134, service request database 136, and work order database 138. Level 3 access provides add, modify or delete access to service request database 136 and work order database 138. Level 4 access provides only read access to database 136 and work order database 138.

The customer users tab is used by the provider to access and modify the name and contact information of each of the customer's users authorized to access the system. The customer user's group tab displays the level of access each customer's user group has to information system i 00. The manage types info tab allows the provider to modify the web pages by building more drop down lists, adding changing or deleting sections to the web pages, or other functions related to the operation of the web page.

Under regional management tab 804 is regions tab, region types tab, customer locations tab, locations lists tab, and provider locations tab. The regions tab, region types tab, customer locations tab, and locations lists tab are all customer specific. The regions tab accesses the region in which each location or item in location list 122 is located. When the regions tab is first selected, the system prompts the provider's employee for a specific customer. The regions type tab provides a listing of all the region types a customer uses. The customer locations tab accesses a listing of each individual customer location or item in location list 122. The location lists tab accesses a customer named list of a group of locations or items. The provider locations tab accesses field partner database 128 and lab partner database 130 and provides a list of the location of all of provider's partners.

Under contracts tab 806 is master contract tab, sub contract tab, contract services tab and analysis segmentation tab. The master contract tab accesses a master contract in relationship database 124. The master contract contains the name of a customer, a description of customer's business, and the start and end date of the relationship the customer has with provider. The sub-contract tab accesses a sub-contract in relationship database 124. The contract services tab accesses service product database 136 and products list database 120 and provides a listing of the services of the provider associated with the products of the customer. The master contract, sub-contract, and listing of the services associated with each product can be read and modified by the provider. The analysis segmentation tab under the contracts tab accesses the grading and notification area 156 in service request database 136. Grading and notification area assigns a “passed/failed” or some other easily recognizable identifier of the status of the test and the meaning of the numerical value.

Grading and notification area 156 allows the provider to define analysis segmentation rules for concentration related tests. FIG. 4 shows an example of a screen shot of the display associated with the grading and notification area wherein the presence of a chemical marker is tested. Data box 850 requires that the provider name the particular analysis segmentation rule to be defined. Data box 851 allows a generic description of the analysis segmentation rule to be entered. At break point box 852, the provider may add a break point for the analysis of data with button 855 and break point data entry box 853. A break point is a concentration level which automatically triggers a certain evaluation response. Insert segment field 858 allows a before button 859 and after button 860. A segment is a range of concentration before or after the break point defined by data entry 853. Delete break point box 861 allows the provider to eliminate break points from segments with a combination of button 856 and drop down list 854. Control buttons 857 allow the provider to edit a particular analysis segmentation rule associated with a particular data test or a certain evaluation response. Graphic display 862 provides a quick reference if all the tests have been passed or failed in the preferred embodiment, a check mark for passage and an “X” for failure.

Continuing with FIG. 4, if the concentration of the chemical marker is greater than or equal to 0 or less than 20 ppm, then the sample being tested fails the test and a notification is sent to the provider and the customer. If the concentration of the chemical marker is greater than or equal to 20 or less than 25 ppm, then the sample being tested does not fail but is suspect and no notification is sent. If the concentration of the chemical marker is greater than or equal to 25 or less than 30 ppm, then the sample being tested is classified as being on the buffer range. If the concentration of the chemical marker is greater than or equal to 30 or less than 33 ppm, then the sample being tested is classified as being safe. If the concentration of the chemical marker is greater than or equal to 33 ppm, then the sample being tested is classified as being over dosing but no notification is sent to the provider or the customer.

Returning to FIG. 3, under catalog tab 808 is COA tab, analysis plans tab, sampling plans tab, product identifier tab, and service products tab. The COA tab accesses procedures database 132 and policies database 134 for a specific named service. The analysis plans tab accesses procedures database 132 for plans relating to analysis. The sampling plans tab accesses procedures database 132 for plans relating to sampling. The product identifier tab accesses procedures database 132 and provides both a group analysis and sampling plan for a specific named product. The service product tab accesses service request database 136 to create or review service requests.

Under processes tab 810 is service request tab and work orders tab. From the service request tab, the provider can access service request database 136. From the work orders tab, the provider can access work order database 138.

Reporting tab 812 catalogs the reports the customer or provider has generated. Reporting tab 812 contains reports tab. The reports tab indicates the number of reports that have been generated and provides a link to those reports in standard query and reporting engine 146 and business intelligence engine 148.

Field work orders display 1114 catalogs the field work orders in work order database 138. Field work orders contains saved category 1126, ready for process category 1128, and in-process category 1130. Saved category 1126, indicates the number of saved work orders that have not been submitted for approval by the provider in work order database 138 and provides a link to the saved work orders. Ready for process category 1128 indicates the number of work orders that are ready for processing but have not been sent out in work order database 138 and provides a link to the work orders that are ready for processing. In process category 1130, indicates the number of work orders in work order database 138 that have been assigned to a field partner and are in the process of being completed and provides a link to the work orders in process. Lab work orders display 1116 catalogs the number of lab work orders in work order database 138. Lab work orders display 1116 contains saved category 1132, ready for process category 1134 and in-process category 1136. Saved category 1132, indicates the number of saved lab work orders that have not been submitted for approval in work order database 138 and provides a link to the saved lab work orders. Ready for process category 1134 indicates the number of lab work orders that are ready for processing but have not been sent out in work order database 138 and provides a link to the lab orders that are ready for process. In-process category 1136 indicates the number of work orders in work order database 138 that have been assigned to a lab partners for completion of the work order and are in process and provides a link to the work orders in process.

Service request display 1118 catalogs service requests for a particular customer in service request database 136. Service request display 118 contains saved category 1138, pending customer approval category 1140, pending provider approval category 1142, approved category 1144, disapproved category 1146, and in-process category 1148. Saved category 1138 indicates the number of saved service requests in service request database 136 and provides a link to the saved service request. Pending customer approval category 1140, indicates the number of service requests pending the customer's approval in service request database 136 and provides a link to the service requests pending the customer's approval. Pending provider approval category 1142 indicates the number of service request pending the provider's approval in service request database 136 and provides a link to the service requests pending the provider's approval. Approved category 1144, indicates the number of approved service requests in service request database 136 and provides a link to the service request that have been approved. Disapproved category 1146, indicates the number of service requests that have been disapproved in service request database 136 and provides a link to the service request that have been disapproved. In-process category 1148, indicates the number of service request that have been sent out and are in process of being completed in service request database 136 and provides a link to the service requests that are in process.

Notifications display 1120 catalogs the notifications from information system 100 to the provider. Notifications display 1120 contains new messages category 1150 and viewed messages category 1152. New messages category 1150 indicates the number of new messages and provides a link to those new messages. Viewed messages category 1152 indicates the number viewed messages and provides a link to those viewed messages.

Reporting display 1122 catalogs the reports that have been generated. Reporting display 1122 contains reports category 1154 and customer reports category 1156. Reports category 1154 indicates the number of reports that have been generated and provides a link to standard query and reporting engine 146 and business intelligence engine 148. Customer reports category 1156, indicates the number of reports that have been generated by the customer in standard query and reporting engine 146 and 148 and provides a link to those created reports.

Administration display 1124 allows the provider's employee to customize the view of the web page. Administration display 1124 contains user preferences category 1158. User preferences category 1158 is used to adjust the appearance of the web page display.

While the invention has been described with a service provider being a provider of sampling and testing services in the gasoline industry and the customer being a producer of gasoline, other providers and customers may use the invention with equal success. For example, the service provider may be a Quality Assurance (QA) testing center for food products and the customer may produce a variety food products. The customer may want QA testing done on various ingredients that comprise a final product. For example, the customer might desire information about the fat content of meat, the moisture content of cheese and the color and mesh size of spices. All the ingredients would require different sampling and testing procedures. Also, each of the ingredients would need to be sampled and possibly tested at different locations. The present invention could provide an easy to use system for ordering specific services and test to be performed on each ingredient and provide current information of the status of each service being performed.

Although the invention has been described with reference to one or more preferred embodiments, this description is not to be construed in a limiting sense. For instance, the databases described may be executed as tables in a larger database. There are other modifications of the disclosed embodiments, as well as alternative embodiments of this invention, which will be apparent to persons of ordinary skill in the art, and the invention shall be viewed as limited only by reference to the following claims.

1. A method of organizing customer service requests to a service provider comprising the steps of:
providing a contract database;
providing a service provider database;
providing a relationship database;
creating a service product database from predetermining elements of the contract database and predetermined elements of the relationship database;
creating a product list database from predetermined elements of the relationship database;
creating a service request database by combing predetermined elements of the service product database and the product list database.

2. The method of claim 1 comprising the additional steps of providing a procedure database and wherein the step of creating a service request database includes combining predetermined elements from the procedure database.

3. The method of claim 1 comprising the additional steps of:
submitting an element of the service request database to the service provider for approval;
upon approval of the service provider, creating a work order corresponding to the element of the service request database.

4. The method of claim 3 wherein the work order is communicated to a field partner.

5. The method of claim 3 wherein the word order is communicated over a computer network.

6. The method of claim 3 wherein the work order is communicated to a lab partner.

7. The method of claim 3 comprising the additional step of providing an account database and allocating funds in the account database according to the element of the service request database.

8. The method of claim 3 comprising the additional step of executing the work order to achieve results.

9. The method of claim 8 comprising the additional step of tracking the status of executing the work order and storing tracking-related information.

10. The method of claim 9 wherein the step of tracking further comprises reporting a completion event when the work order execution is complete.

11. The method of claim 10 wherein the step of reporting is completed through a computer network.

12. The method of claim 11 wherein the step of reporting is completed through email.

13. The method of claim 10 comprising the additional step of interpreting the completion event.

14. The method of claim 13 wherein the step of interpreting comprises examining a concentration of a marker and storing interpretation results.

15. The method of claim 10 wherein the step of reporting further comprises reporting the completion event in a graphical format.

16. The method of claim 10 comprising the additional step of interpreting the completion event.

17. The method of claim 16 wherein the step of interpreting comprises examining a concentration of a marker and storing interpretation results.

18. The method of claim 17 wherein the step of examining further comprises concluding if the concentration is above a predetermined level.

19. The method of claim 9 comprising the step of accessing the tracking-related information through a computer network.

20. The method of claim 19 wherein the computer network is the Internet.

21. The method of claim 9 wherein the step of storing a completion event when the work under execution is complete.

22. The step of claim 21 comprising the additional step of accessing the completion event through a computer network.

23. The method of claim 3 wherein the step of submitting is carried out by the customer.

24. The method of claim 1 comprising the additional step of providing a location list database and where the step of creating a service request database further comprises combining predetermined elements of the location list database.

25. The method of claim 1 comprising the additional step of accessing the relationship database through a computer network.

26. The method of claim 25 wherein the step of examining further comprises concluding if the concentration is above a predetermined level.

27. A method of organizing customer service requests to a service provider comprising the steps of:
providing a procedures database containing service specification information;
providing a service provider database containing service provider information;
providing a relationship database containing customer identification information, service request information and product information;
providing a location list database containing location information;
creating a service product database from service specification information and service request information;
creating a product list database from the product information;
creating a service request database by combining predetermined elements of the procedures database, the service product database, the product list database, and the location list database; and
creating a work order database from a predetermined element of the service request database.

28. The method of claim 27, wherein the predetermined element of the service request database is submitted to the service provider for approval.

29. The method of claim 28 comprising the additional step of executing the work order to achieve results.

30. The method of claim 29 comprising the additional step of tracking the status of executing the work order and storing tracking-related information.

31. The method of claim 30 comprising the step of accessing the tracking-related information through a computer network.

32. The method of claim 31 wherein the computer network is the Internet.

33. The method of claim 32 wherein the step of reporting further comprises reporting the completion event in a graphical format.

34. The method of claim 30 wherein the step of reporting is completed through a computer network.

35. The method of claim 34 wherein the step of reported is completed through email.

36. The method of claim 28 wherein the work order database is created only upon approval by the service provider.

37. The method of claim 27 wherein the service specification information can be accessed through a computer network.

38. The method of claim 27 wherein the service provider information can be accessed through a computer network.

39. The method of claim 27 wherein the customer identification information can be accessed through a computer network.

40. The method of claim 27 wherein the production information can be accessed through a computer network.

41. The method of claim 27 wherein the location information can be accessed through a computer network.

42. The method of claim 41 wherein the step of tracking further comprises reporting a completion event when the work order execution is complete.

43. The method of claim 41 wherein the step of storing a completion event when the work order execution is complete.

44. The method of claim 43 comprising the additional step of accessing the completion event through a computer network.

45. The method of claim 27 wherein the customer service requests come from a plurality of customers.

46. The method of claim 27 comprising the additional step of providing a field partner database containing field partner identification information.

47. The method of claim 46 wherein the step of creating the service product database further comprises creating a service product database from the service specification information and the field partner identification information.

48. The method of claim 46 wherein the step of creating the service product database further comprises creating a service product database from the service specification information and the lab partner identification information.

49. The method of claim 27 comprising the additional step of providing a lab partner database comprising lab partner identification information.

50. A method of organizing a plurality of service requests to a service provider comprising the steps of:
providing a procedures database containing a plurality of testing service procedures;
providing a service provider database containing information related to an identification of at least one provider partner;
providing a location list database containing the location of product to be tested;
entering customer identification information, at least one service request and an identification of at least one product to be tested into a co-relational relationship database;
creating a matched service request by associating at least one service request with at least one testing service procedure;
creating a service product database containing the matched service request;
creating a matched provider identification by associating at least one partner with at least one testing service procedure;
creating a product list database from the identification of the product to be tested;
creating a service request database by combining the identification of the product to be tested, the matched service request, the location of the product to be tested and the matched provider identification;
submitting a selected service request from the service request database to the service provider for approval;
if approval is made, creating a work order database incorporating the selected service request; and
distributing the selected service request according to the matched provider information.

51. The method of claim 50 comprising the additional step of monitoring the matched service request and recording status information.

52. The method of claim 51 comprising the additional step of reporting the status information.

53. The method of claim 51 comprising the additional step of reporting the status information through a computer network.

54. The method of claim 51 further comprising recording completion of the matched service request.

55. The method of claim 54 comprising the additional step of reporting the completion of the matched service request.

56. The method of claim 54 comprising the additional step of reporting the completion of the matched service request graphically.

57. The method of claim 54 comprising the additional step of reporting the completion of the matched service request through a computer network.

58. The method of claim 54 further comprising the step of accessing the recorded completion of the matched service request through a computer network.

59. The method of claim 51 further comprising the step of accessing the recorded status information through a computer network.

60. The method of claim 50 wherein the procedures database may be accessed through a computer network.

61. The method of claim 50 wherein the service provider database may be accessed through a computer network.

62. The method of claim 50 wherein the location list database may be accessed through a computer network.

63. The method of claim 50 wherein the relationship database may be accessed through a computer network.

64. The method of claim 50 wherein the service product database may be accessed through a computer network.

65. The method of claim 50 wherein the product list database may be accessed through a computer network.

66. The method of claim 50 wherein the service request database may be accessed through a computer network.

67. The method of claim 50 wherein the work order database may be accessed through a computer network.

68. The method of claim 50 wherein the customer may cancel the service request.

69. The method of claim 50 wherein the service provider may cancel the service request.

70. The method of claim 50 wherein the location list database is organized regionally.
